(19) United States
(12) Patent Application Publication
(10) Pub. No.: US 2007/0299917 A1
(43) Pub. Date: Dec. 27, 2007

(54) METHOD, APPARATUS, AND COMPUTER PROGRAM PRODUCT FOR INSTANT MESSAGING

(76) Inventors: KULVIR BHOGAL, FORT WORTH, TX (US); NIZAMUDEEN ISHMAEL, AUSTIN, TX (US); MANDEEP SIDHU, PFLUGERVILLE, TX (US)

Correspondence Address: IBM CORP (YA);C/O YEE & ASSOCIATES PC, P.O. BOX 802333, DALLAS, TX, 75380, US

(21) Appl. No.: 11/425,905

(22) Filed: Jun. 22, 2006

(51) Int. Cl. G06F 15/16

(52) U.S. Cl. 709/206

(57) ABSTRACT

A method, apparatus and computer program product for instant messaging between one or more clients. An instant messaging partner (e.g., buddy) can be associated with specialized text, lists, or programs.

### BACKGROUND

1. Technical Field of the Present Invention

The present invention generally relates to electronic devices and, more specifically, to methods, apparatuses, and computer program products that provide the user with the ability to communicate with another individual via the use of text on an electronic device.

2. Description of Related Art

In the last decade, the Internet has revolutionized communication from traditional letters to e-mail. Billions of e-mail messages are sent and received everyday by numerous individuals from all aspects of life.

Email, which was once considered incredibly fast, is now to slow for a society that expects instantaneous results. One problem is that the sender is unable to determine whether the recipient of the email is online or available. Even assuming that the recipient is online at the same time as the sender, the transmission of multiple emails back and forth between the individuals is unacceptable for any conversation that cannot last over an extended period of time. Consequently, instant messaging has evolved to fill this need for instantaneous communication.

In general, instant messaging allows you to maintain a list of people with whom you desire to interact (e.g., a buddy list) and display whether that individual is available, busy, or away. In addition, you can initiate a conversation with one of the listed individuals in real-time. Instant messaging is rapidly becoming a preferred method for initiating quick and to the point conversations in both the commercial and non-commercial environments.

Although instant messaging has provided a means for instantaneous communication between two or more individuals, it fails to allow an individual to create customizable prompts that can be displayed in response to the change in the status of a buddy. In addition, it also lacks the ability to tie or maintain information with respect to a particular “buddy” (e.g., a discussion list). In fact, if a user desires this type of functionality they must use separate distinct programs in addition to the instant messaging.

It would, therefore, be a distinct advantage to have a method, apparatus, and computer program product that would allow an individual to create specialized prompts for buddies. It would be further advantageous if the individual could also associate or maintain additional information with each buddy in a simple manner.

### SUMMARY OF THE PRESENT INVENTION

In one aspect, the present invention is a method of instant messaging between one or more individuals. The method includes the step of creating a buddy list containing one or more individuals that frequently receive instant messaging. The method also includes the step of creating a customizable action to be taken for one of the individuals whenever their status changes.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating a communication system for instant messaging between clients;

FIG. 3 is a flow chart illustrating a method for providing instant messaging on the communication system of FIG. 2;

FIG. 4 is a diagram illustrating an instant messaging program that is executing on each one of the clients of FIG. 2;

FIG. 5 is a diagram illustrating instant messaging between two of the clients of FIG. 2;

FIG. 6 is a flow chart illustrating the method for associating specialized text, lists or programs with one or more of the buddies listed in the instant messaging program of FIG. 4 according to the teachings of a preferred embodiment of the present invention;

FIG. 7 is a diagram illustrating the selection of one of the listed buddies (e.g., Buddy 2) using a cursor and right clicking the intended buddy according to the teachings of a preferred embodiment of the present invention;

FIG. 8 is a diagram illustrating a pop-up window that displays the various associations that can be attached to the selected buddy of FIG. 7 according to the teachings of a preferred embodiment of the present invention;

FIG. 9 is a diagram illustrating a pop-up window that is displayed as a result of the selection of customized text association of FIG. 8 according to the teachings of a preferred embodiment of the present invention;

FIG. 10 is a diagram illustrating a pop-up window for specialized text for buddy2 according to a preferred embodiment of the present invention;

FIG. 11 is a diagram illustrating the selection of the list association from the pop-up window of FIG. 7 according to the teachings of a preferred embodiment of the present invention;

FIG. 12 is a diagram illustrating a pop-up window displaying a check list of items according to the teachings of a preferred embodiment of the present invention;

FIG. 13 is a diagram illustrating the selection of the calendar association of FIG. 7 according to the teachings of a preferred embodiment of the present invention;

FIG. 14 is a diagram illustrating a pop-up window that is displayed as a result of the selection of calendar association of FIG. 8 according to the teachings of a preferred embodiment of the present invention; and

FIG. 15 is a diagram illustrating a pop-up notification window according the teachings of a preferred embodiment of the present invention.

### DETAILED DESCRIPTION OF THE PREFERRED EMBODIMENT OF THE PRESENT INVENTION

The present invention is a method, apparatus and computer program product for providing the ability to create customizable text messages for buddies and to associate a buddy with a particular program such as a “to-do” list or calendar.

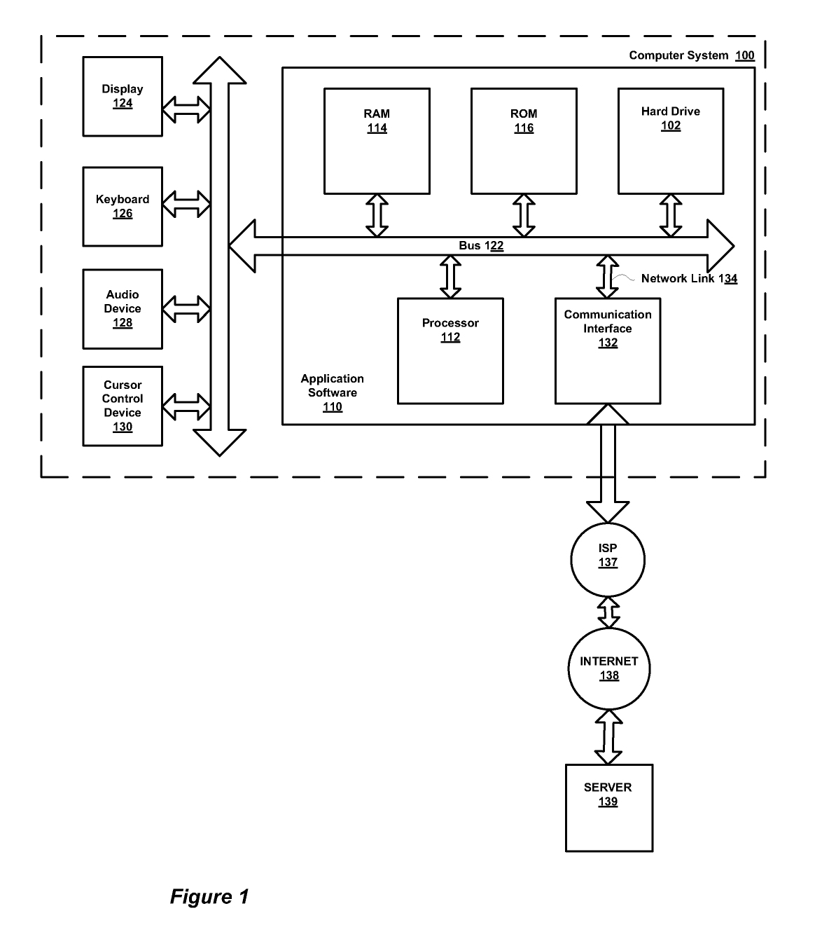

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

The application software 110 can be an instant messaging program such as SameTime™ by IBM. The execution of the application software 110 on computer system 100 is explained in greater detail below.

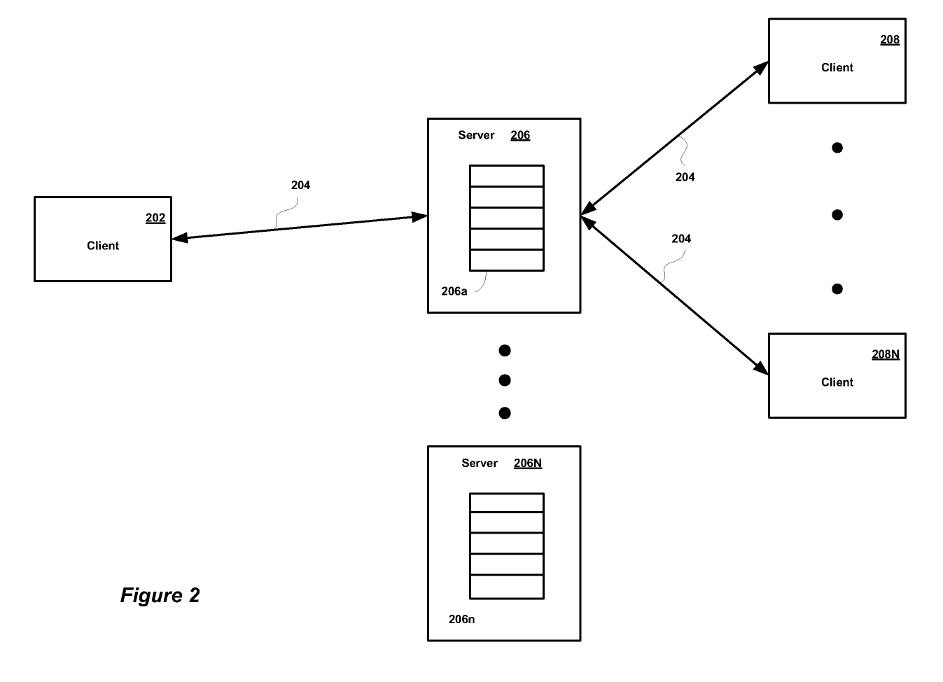

Reference now being made to FIG. 2, a diagram is shown illustrating a communication system 200 for instant messaging between clients 202 and 208-N. Communication system 200 includes servers 206-N, clients 202, 208-N, and communication medium 204.

Clients 202 and 208-N can be any type of computer system capable of supporting instant messaging communication (e.g., computer system 100, cell phone, PDA, and the like).

Server 206 is representative of any type of computer that is capable of providing instant messaging services (e.g., a web server). In this example, Server 206 maintains a list 206a of users of the instant messaging service and their status.

Communication medium 204 provides communication between each of the clients 201 and 208-N and server 206, and can be implemented using well-known and understood configurations (e.g., ISP 137 and Internet 138 of FIG. 1).

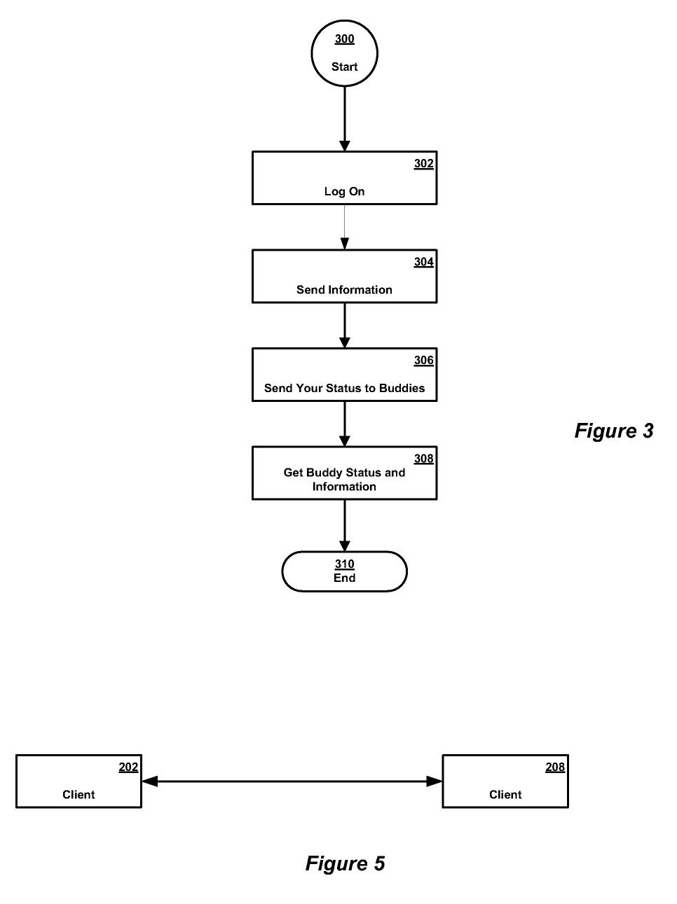

Details concerning the provision of instant messaging by the server 206 to clients 201 and 208-N are explained in connection with FIG. 3 below.

Reference now being made to FIG. 3, a flow chart is shown illustrating a method for providing instant messaging on the communication system 200 of FIG. 2. For the moment, it can be assumed that each of the clients 201 and 208-N has installed instant messaging software, subscribed to an instant messaging service supported by server 206, and that each user of client 201 and 208-N is a buddy of the other.

The method begins when one of the users of one of the clients such as client 202 initiates an instant messaging session by connecting to server 206 and logging on to the instant messaging service (Steps 300-302). Once communication has been established, client 202 sends the server 206 connection information for client 202 (i.e., IP address and port assigned to the instant messaging software, and buddy list (alternatively, the buddy list can be kept at server 206)) (Step 304).

Server 206 sends the status of each listed buddy to client 202 and the status of the user of client 202 to any other clients 208-N that have this user listed as a buddy (Step 306). If server 206 determines that any of the other users of clients 208-N are logged on, then it sends their connection information to client 202 and the connection information for client 202 to them (Step 308).

Upon receiving the connection information, client 202 and clients 208-N update the status of their buddy lists accordingly (e.g., status=active if signed in) and a notification such as “buddy 1 is signed in” or “buddy 1 is signed out” is displayed in a pop-up window or the like. A conversation can be initiated with an active buddy at this time (Step 310).

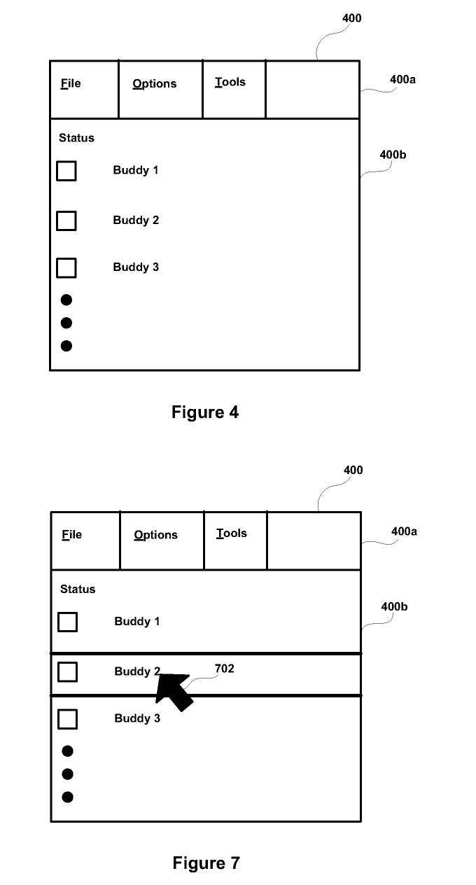

Reference now being made to FIG. 4, a diagram is shown illustrating an instant messaging program 400 that is executing on each one of the clients 202 and 208-N of FIG. 2. The instant messaging program 400 includes a menu bar 400a having typical menu items such as “File”, “Options”, and “Tools”, and a buddy list 400b. The buddy list 400b maintains a list of individuals with whom the user of client 202 frequently messages and their current status.

The user of client 202 can initiate a conversation with any active buddy such as buddy1 by double clicking them. In this example, it can be assumed that buddy 1 represents the user on client 208. The instant messages between client 202 and client 208 are sent directly to each of their respective IP address and port as illustrated in FIG. 5.

The problem with existing solutions for instant messaging services is that they fail to provide any means for customizing the messages that are displayed when the status of a buddy changes. In addition, they also fail to allow the user to associate lists or other programs with a particular buddy. The present invention provides these additional features as explained below.

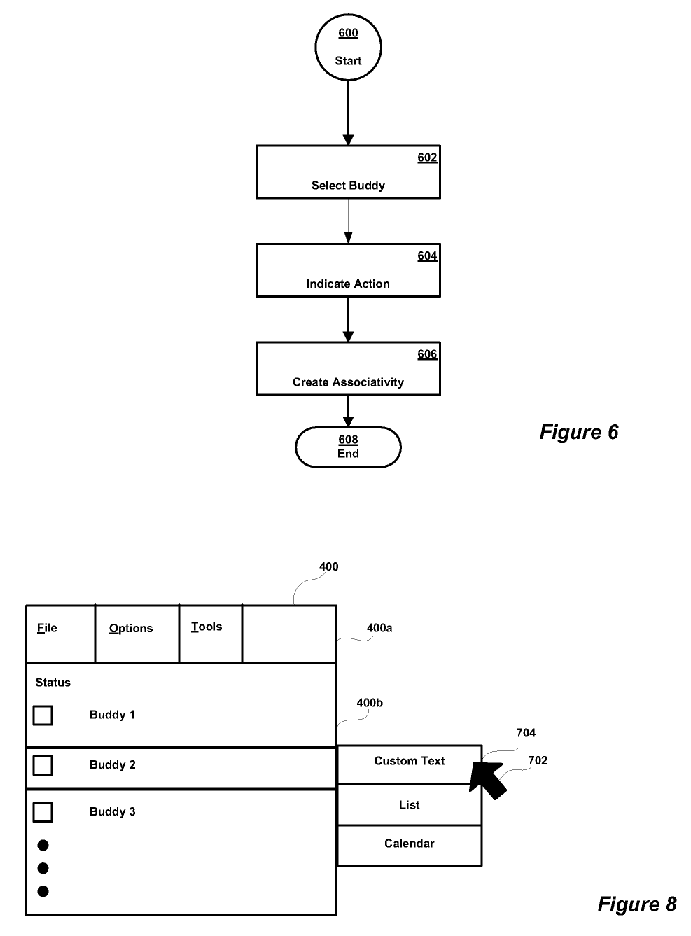

Reference now being made to FIG. 6, a flow chart is shown illustrating the method for associating specialized text or programs with one or more of the buddies listed in the instant messaging program 400 of FIG. 4 according to the teachings of the present invention. The method begins upon the selection of one of the listed buddies (e.g., Buddy 2) as indicated in FIG. 7 using the cursor 702 and right clicking the intended buddy (Steps 600-602).

It should be noted that the particular means used for selecting the buddy can be numerous and are specific to the particular design supported by the instant messaging program, and therefore, the current example of double clicking and the use of pop-up windows are not to be considered a limitation on the many applications of the present invention, but rather, as a convenient manner in which to provide an explanation.

The method continues when the instant messaging program 400 (via itself or a plug-in), in response to the selection of buddy 2, creates a pop-up window 704 to display the various associations that can be attached to buddy 2 as shown in FIG. 8. In this example, the user is provided with the ability to associate customized text, create a list, or a calendar event. For the moment, it can be assumed that a user has selected the customized text as illustrated by cursor 702 in FIG. 8.

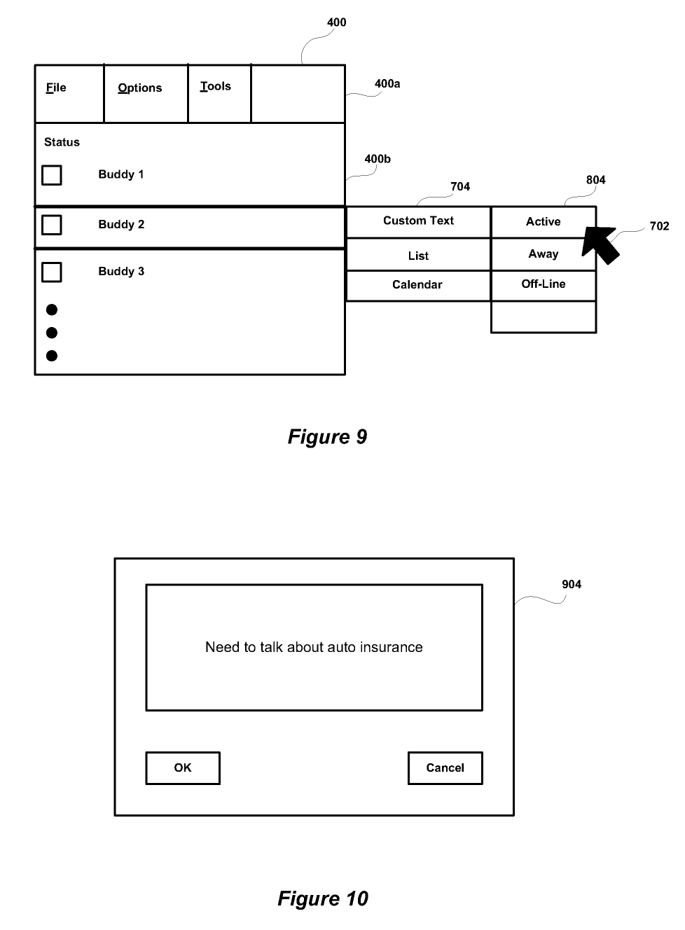

In response to the selection, another pop-up window or menu list 804 is displayed as shown in FIG. 9. The window 804 provides the user with the selection of various types of supported status indications for buddy2. In this example, the supported status indications are “Active”, “Away”, and “Off-line”. It can be assumed that the user has selected the “Active” status as indicated with cursor 702 in FIG. 9.

In response to this selection, a pop-up window 904 is created and the user is provided with the ability to type any specialized text for buddy2 that would be displayed upon the status of buddy 2 becoming active as shown in FIG. 10. For example, as shown, the text can display “Need to talk about auto insurance” the next time buddy 2 becomes active (Steps 606-608).

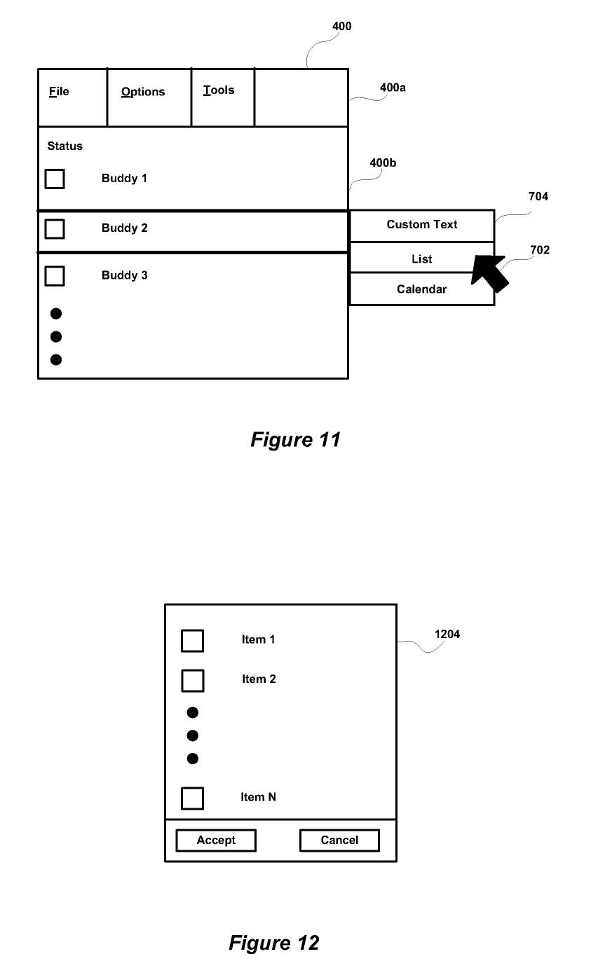

Alternatively, the user could have selected another option such as list from pop-window 704 as shown in FIG. 11. In this case, a pop-up window 1204 is created that has a checklist of items 1-N that are associated with buddy2 as shown in FIG. 12. The pop-up window 1204 can include functionality that is typically associated with “to do” list type programs such as Lotus Notes by IBM (e.g., the ability to prioritize show status etc. . . . ).

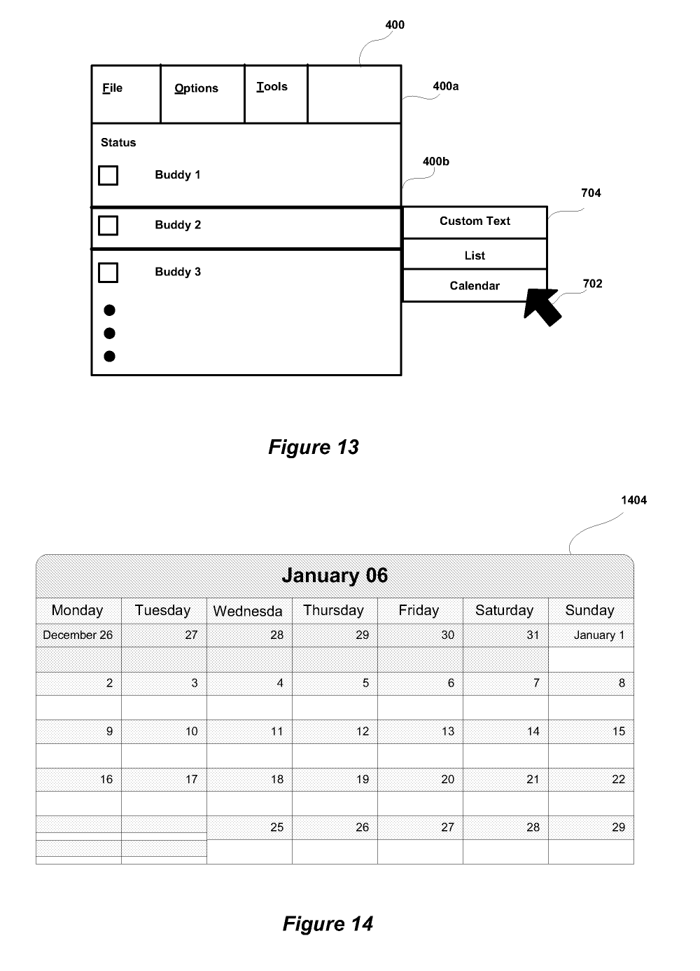

The user could have also selected another option that allows one or more programs to be associated with a particular buddy. For example, the user could have selected the calendar option as illustrated in FIG. 13.

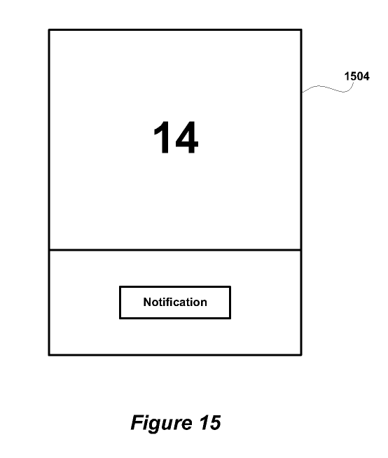

In this instance, a pop-up window 1404 for displaying a calendar is displayed as shown in FIG. 14. The calendar program supports typical functionality such as appointment scheduling and the like, except in this case, when information is entered on a particular day the user is provided with an additional option of providing a notification associated with Buddy2 when the day and/or time arrives as shown in FIG. 15 with the notification selection button.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A method of instant messaging between one or more individuals, the method comprising:
creating a buddy list containing one or more individuals that frequently receive instant messaging; and
creating a customizable action to be taken for one of the individuals whenever their status changes.

2. The method of claim 1 wherein the customizable action is displaying a specialized text message.

3. The method of claim 2 wherein the specialized text message is displayed when the status of the individuals changes from inactive to active.

4. The method of claim 3 wherein the specialized text message includes a list of items.

5. The method of claim 1 wherein the action is displaying a list of items.

6. The method of claim 1 wherein the action is executing a program.

7. The method of claim 6 wherein the action is assigning a day and time to display a specialized message for the individual.

8. An apparatus for instant messaging between one or more individuals, the apparatus comprising:
means for creating a buddy list containing one or more individuals that frequently receive instant messaging; and
means for creating a customizable action to be taken for one of the individuals whenever their status changes.

9. The apparatus of claim 8 wherein the customizable action is displaying a specialized text message.

10. The apparatus of claim 9 wherein the specialized text message is displayed when the status of the individuals changes from inactive to active.

11. The apparatus of claim 10 wherein the specialized text message includes a list of items.

12. The apparatus of claim 8 wherein the action is displaying a list of items.

13. The apparatus of claim 8 wherein the action is executing a program.

14. The apparatus of claim 13 wherein the action is assigning a day and time to display a specialized message for the individual.

15. A computer program product comprising a computer usable medium having computer usable program code for instant messaging between one or more individuals, the computer usable program code comprising:
computer usable program code for creating a buddy list containing one or more individuals that frequently receive instant messaging; and
computer usable program code for creating a customizable action to be taken for one of the individuals whenever their status changes.

16. The computer program product of claim 15 wherein the customizable action is displaying a specialized text message.

17. The computer program product of claim 16 wherein the specialized text message is displayed when the status of the individuals changes from inactive to active.

18. The computer program product of claim 17 wherein the specialized text message includes a list of items.

19. The computer program product of claim 15 wherein the action is displaying a list of items.

20. The computer program product of claim 15 wherein the action is executing a program.
